(19) United States
(12) Patent Application Publication
(10) Pub. No.: US 2012/0177243 A1
(43) Pub. Date: Jul. 12, 2012

(54) EARPHONE CONNECTOR OF MOBILE TERMINAL

(75) Inventors: Jae Kwang Lee, Suwon-si (KR); Hong Gu Kim, Hwasung-si (KR)

(73) Assignee: SAMSUNG ELECTRONICS CO., LTD., Suwon-si (KR)

(21) Appl. No.: 13/346,703

(22) Filed: Jan. 9, 2012

(30) Foreign Application Priority Data
Jan. 10, 2011 (KR) 10-2011-0002257

(51) Int. Cl. H04R 1/10

(52) U.S. Cl. 381/384

(57) ABSTRACT

An earphone connector of a mobile terminal prevents noise from occurring when inserting and removing an earphone. The earphone connector of a mobile terminal includes a main body having a passage for inserting an earphone. Aground terminal, aright sound terminal, and a left sound terminal are disposed at a preset position of the main body to contact with a corresponding ground terminal, right sound terminal, and left sound terminal of the earphone, respectively, when the earphone is inserted into the passage. A microphone terminal contacts with a corresponding microphone terminal of the earphone when the earphone is fully inserted. And an elastic member applies an external force such that the microphone terminal does not contact with at least one of the corresponding right sound terminal and the left sound terminal of the earphone before the earphone is fully inserted.

### CROSS-REFERENCE TO RELATED APPLICATION(S) AND CLAIM OF PRIORITY

The present application is related to and claims the benefit of priority to Korean Patent Application No. 10-2011-0002257, filed on Jan. 10, 2011, in the Korean Intellectual Property Office, the disclosure of which is incorporated herein in its entirety by reference.

### TECHNICAL FIELD OF THE INVENTION

The present invention relates to an earphone connector of a mobile terminal, and more particularly, to an earphone connector of a mobile terminal that can prevent noise from occurring when inserting and removing an earphone.

### BACKGROUND OF THE INVENTION

Nowadays, due to the remarkable development of information and communication technology and semiconductor technology, use of mobile terminals has rapidly increased and become widespread. Particularly, recent mobile terminals perform mobile convergence including various functions of other terminals in addition to an existing communication function. A typical mobile communication terminal provides various functions such as a television viewing function (e.g. mobile broadcasting such as digital multimedia broadcasting (DMB) or digital video broadcasting (DVB)), music reproduction function (e.g. MPEG Audio Layer-3 (MP3)), photographing function, Internet connection function, radio receiving function, and earphone communication function in addition to a communication function such as voice communication and a text messaging service.

For earphone communication, a 4-pole earphone connector including a microphone terminal is generally mounted in the mobile terminal. FIG. 1 illustrates an example of the 4-pole earphone connector.

Referring to FIG. 1, a conventional 4-pole earphone connector 10 includes a microphone terminal 1, ground terminal 2, right sound terminal 3, and left sound terminal 4. When a 4-pole earphone 20 is inserted into the conventional 4-pole earphone connector 10, the microphone terminal 1 of the 4-pole earphone connector 10 and a right sound terminal R of the 4-pole earphone 20 contact, as shown in FIG. 1. In this situation, noise due to microphone bias power is output to the 4-pole earphone 20. Further, even when the microphone terminal 1 of the 4-pole earphone connector 10 and a left sound terminal L of the 4-pole earphone 20 contact, such noise may occur. Even when removing an earphone, such noise similarly occurs. Due to occurrence of such noise, a user feels an unpleasant feeling when inserting or removing the earphone.

### SUMMARY OF THE INVENTION

To address the above-discussed deficiencies of the prior art, it is a primary object to provide an earphone connector of a mobile terminal that can prevent noise from occurring when inserting or removing an earphone.

According to one aspect of the present disclosure, an earphone connector of a mobile terminal is provided. The earphone connector includes a main body, a ground terminal, a right sound terminal, a left sound terminal, a microphone terminal, and an elastic member. The main body includes a passage for inserting an earphone. The ground terminal, the right sound terminal, and the left sound terminal are disposed at a preset position of the main body to contact with a corresponding ground terminal, right sound terminal, and left sound terminal of the earphone, respectively, when the earphone is inserted into the passage. The microphone terminal contacts with a corresponding microphone terminal of the earphone when the earphone is fully inserted. And the elastic member applies an external force such that the microphone terminal does not contact with at least one of the corresponding right sound terminal and the left sound terminal of the earphone before the earphone is fully inserted.

According to another aspect of the present disclosure, a mobile terminal is provided. The mobile terminal includes a mobile terminal body and an earphone connector. The earphone connector, which is mounted in the mobile terminal body to connect an earphone that includes a microphone, includes a main body, a ground terminal, a right sound terminal, a left sound terminal, a microphone terminal, and an elastic member. The main body includes a passage for inserting an earphone. The ground terminal, the right sound terminal, and the left sound terminal are disposed at a preset position of the main body to contact with a corresponding ground terminal, right sound terminal, and left sound terminal of the earphone, respectively, when the earphone is inserted into the passage. The microphone terminal contacts with a corresponding microphone terminal of the earphone when the earphone is fully inserted. And the elastic member applies an external force such that the microphone terminal does not contact with at least one of the corresponding right sound terminal and the left sound terminal of the earphone before the earphone is fully inserted.

According to yet another aspect of the present disclosure, an earphone connector is provided. The earphone connector includes a cavity, a ground terminal, a right sound terminal, a left sound terminal, and a microphone terminal. The cavity includes an open end and a closed end for inserting an earphone through the open end toward the closed end. The ground terminal, the right sound terminal, and the left sound terminal are disposed at positions along the cavity such that each of the ground terminal, the right sound terminal, and the left sound terminal is configured to make contact with a corresponding ground terminal, a corresponding right sound terminal, and a corresponding left sound terminal of the earphone, respectively, when the earphone is fully inserted into the cavity. The microphone terminal makes contact with a corresponding microphone terminal of the earphone when the earphone is fully inserted into the cavity such that the microphone does not make contact with at least one of the corresponding ground terminal, the corresponding right sound terminal, and the corresponding left sound terminal of the earphone while the earphone is being inserted into the cavity.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a diagram illustrating a conventional earphone connector of a mobile terminal;

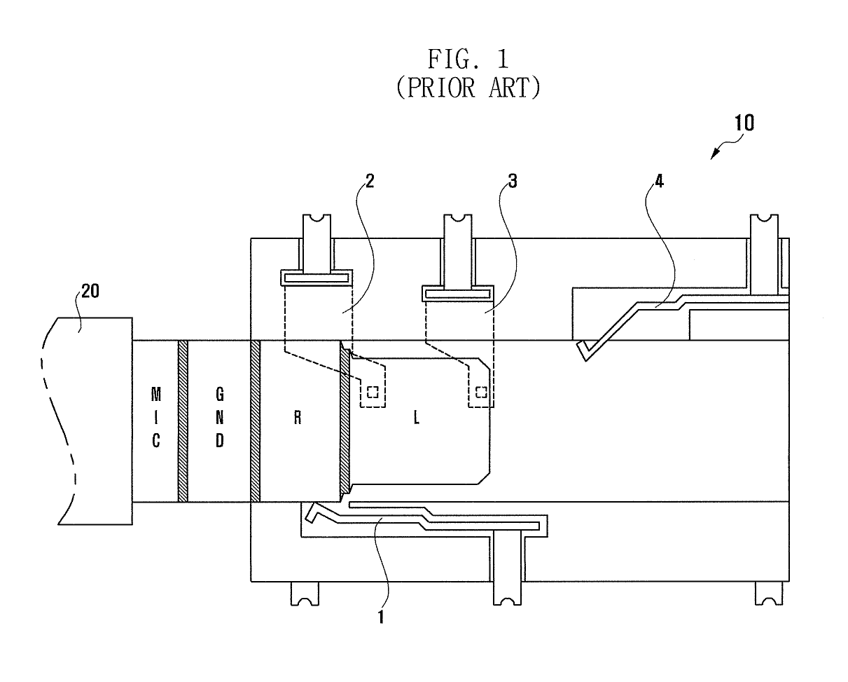

FIG. 2 is a diagram illustrating a structure of an earphone connector of a mobile terminal according to an embodiment of the present invention;

FIG. 3 is a diagram illustrating a state in which an earphone is inserted into the earphone connector of the mobile terminal of FIG. 2;

FIG. 4 is a diagram illustrating a structure of an earphone connector of a mobile terminal according to an embodiment of the present invention; and

FIG. 5 is a diagram illustrating a state in which an earphone is inserted into the earphone connector of the mobile terminal of FIG. 4.

### DETAILED DESCRIPTION OF THE INVENTION

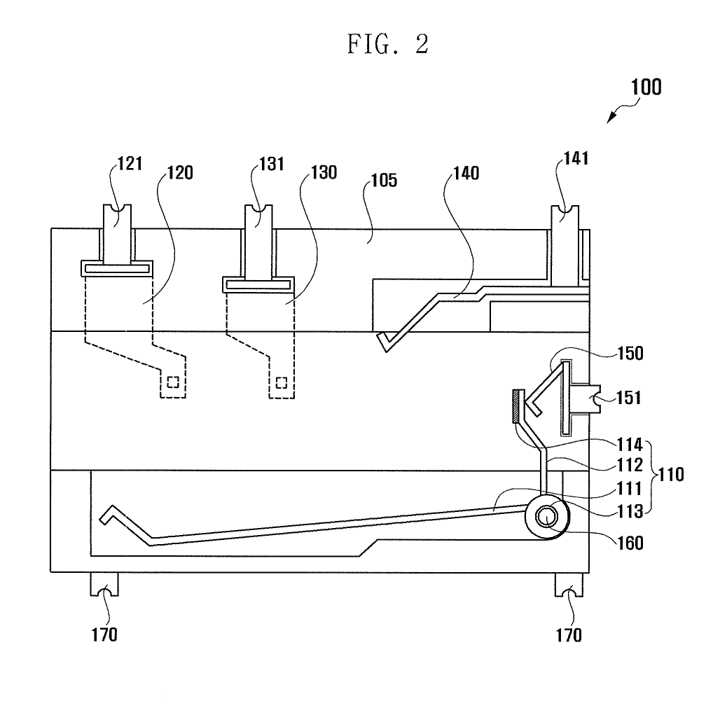

FIGS. 2 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged earphone connector. The same reference numbers are used throughout the drawings to refer to the same or like parts. The views in the drawings are schematic views only, and are not intended to be to scale or correctly proportioned. Detailed descriptions of well-known functions and structures incorporated herein may be omitted to avoid obscuring the subject matter of the present invention.

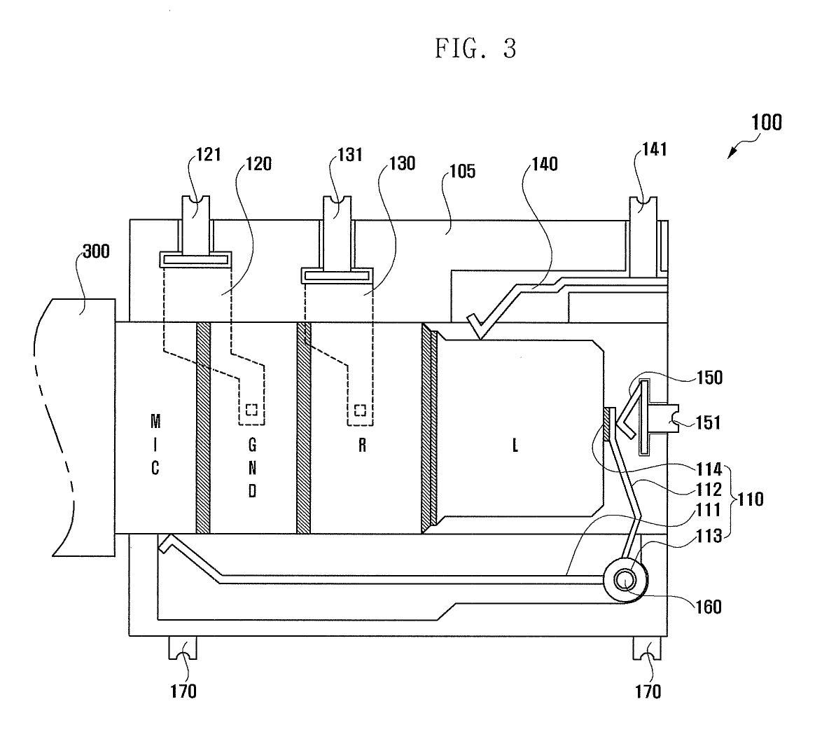

FIG. 2 is a diagram illustrating a structure of an earphone connector of a mobile terminal according to an embodiment of the present invention, and FIG. 3 is a diagram illustrating a state in which an earphone is inserted into the earphone connector of the mobile terminal of FIG. 2.

Hereinafter, a 4-pole earphone and a 4-pole earphone connector are used as examples to describe embodiments of the present disclosure. However, the present invention is not limited thereto. That is, an earphone connector according to an embodiment includes a microphone terminal and can be formed as 4-pole or more earphone connectors (e.g. 5-pole earphone connector) that can detach a 3.5 mm earphone.

Referring to FIGS. 2 and 3, an earphone connector 100 of a mobile terminal according to an embodiment of the present invention includes a main body 105 that includes a passage for inserting an earphone 300, microphone terminal 110, ground terminal 120, right sound terminal 130, left sound terminal 140, elastic member 150, rotation shaft 160, and at least one fixing terminal 170 for fixing the main body 105 to a printed circuit board (PCB) (not shown).

The ground terminal 120, right sound terminal 130, and left sound terminal 140 are fixed and mounted to a preset position of the main body 105 so as to contact with corresponding terminals of the 4-pole earphone 300. For example, as shown in FIG. 3, when the 4-pole earphone 300 is inserted, the ground terminal 120 contacts with a ground terminal GND of the 4-pole earphone 300, the right sound terminal 130 contacts with a right sound terminal R of the 4-pole earphone 300, and the left sound terminal 140 contacts with a left sound terminal L of the 4-pole earphone 300. In this situation, it is preferable that the ground terminal 120, right sound terminal 130, and left sound terminal 140 have elasticity in order to stably contact with the 4-pole earphone 300.

The ground terminal 120, right sound terminal 130, and left sound terminal 140 include connection terminals 121, 131, and 141 for mounting the ground terminal 120, right sound terminal 130, and left sound terminal 140, respectively, in the PCB (not shown). The connection terminals 121, 131, and 141 perform a function of fixing the main body 105 to the PCB. Further, the connection terminals 121, 131, and 141 perform a function as a signal transmission path between the 4-pole earphone 300 and the PCB.

When the 4-pole earphone 300 is not fastened or is not completely inserted, the microphone terminal 110 does not contract with the 4-pole earphone 300, and when the 4-pole earphone 300 is completely fastened, the microphone terminal 110 contacts with a microphone terminal MIC of the 4-pole earphone 300. For this, the microphone terminal 110 includes a first connection portion 111 having one side contacting with the microphone terminal MIC of the 4-pole earphone 300, a second connection portion 112 extended to have a predetermined angle from the first connection portion 111 at an end portion of the other side of the first connection portion 111, and a hole 113 formed in a connection portion of the first connection portion 111 and the second connection portion 112 and for inserting the rotation shaft 160. That is, the microphone terminal 110 can rotate within a predetermined angle range about the rotation shaft 160. Specifically, before insertion of the earphone is complete, the microphone terminal 110 is positioned not to contact with the microphone terminal MIC of the 4-pole earphone 300 by an elastic force of the elastic member 150, as shown in FIG. 2, and when insertion of the 4-pole earphone 300 is complete, one side of the first connection portion 111 contacts with the microphone terminal MIC of the 4-pole earphone 300, as shown in FIG. 3.

In order to prevent microphone bias power supplied from the PCB from being supplied to the left sound terminal L of the 4-pole earphone 300, it is preferable that the second connection portion 112 includes an insulation member 114 in a surface of the second connection portion 112 contacting with the left sound terminal L. For example, in an embodiment, an insulation material (e.g. an insulation tape, rubber) may be attached to a surface of the second connection portion 112 contacting with the left sound terminal L of the second connection portion 112, or a surface of the second connection portion 112 contacting with the left sound terminal L may be coated with an insulation material.

The elastic member 150 is formed with a material having an elastic force, is positioned at the center of an end portion of a passage for inserting the 4-pole earphone 300, and presses the second connection portion 112 of the microphone terminal 110 in the passage direction. That is, when the 4-pole earphone 300 is not inserted, as shown in FIG. 2, before insertion of the 4-pole earphone 300 is complete, the elastic member 150 can apply an external force (elastic force) to the microphone terminal 110 such that the microphone terminal 110 does not contact with the right sound terminal R or the left sound terminal L. When the 4-pole earphone 300 is fully inserted into the 4-pole earphone connector 100, the left sound terminal L of the 4-pole earphone 300 pushes the second connection portion 112 in a traveling direction (insertion direction). In this situation, because an inserting force of the 4-pole earphone 300 is larger than an elastic force of the elastic member 150, the microphone terminal 110 rotates about the rotation shaft 160, and due to the rotation, the first connection portion 111 of the microphone terminal 110 contacts with the microphone terminal MIC of the 4-pole earphone 300, and the elastic member 150 is compressed, as shown in FIG. 3. Alternatively, when the 4-pole earphone 300 is removed, the microphone terminal 110 is moved to a first position by an elastic force of the elastic member 150 and thus the microphone terminal 110 does not contact with the right sound terminal R or the left sound terminal L of the 4-pole earphone 300. Therefore, in the present invention, when the 4-pole earphone 300 is inserted or removed, noise can be prevented from occurring.

The elastic member 150 includes a connection terminal 151 to be mounted in the PCB. The connection terminal 151 of the elastic member 150 performs a function of fixing the elastic member 150 to the PCB and performs a function as a transmission path of a microphone signal between the 4-pole earphone 300 and the PCB. For this, the connection terminal 151 of the elastic member 150 receives microphone bias power from a power unit (not shown) on the PCB and transmits the microphone bias power to a microphone (not shown) of the 4-pole earphone 300 through the microphone terminal 110. The elastic member 150 may be formed in a ‘C’-shaped clip in order to stably contact with and stably supply power to the second connection portion 112.

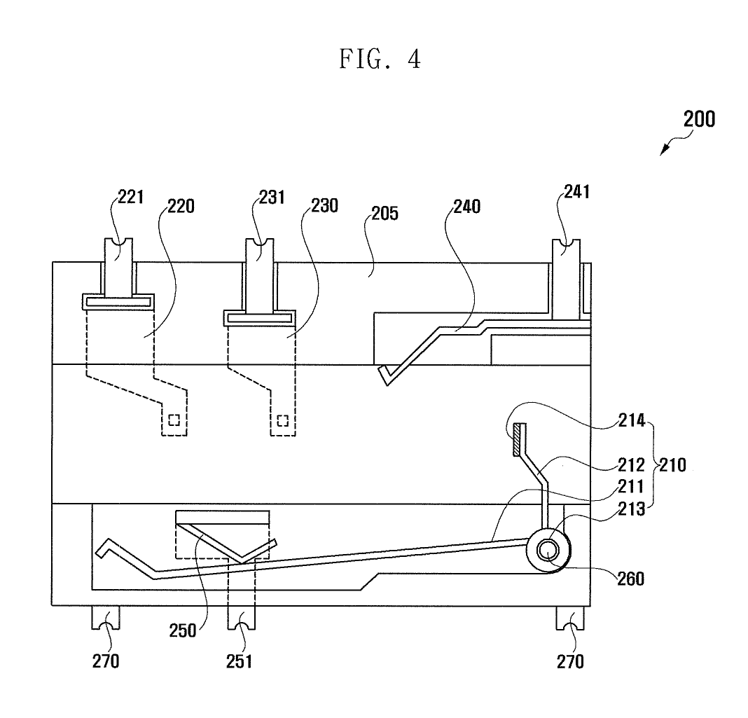

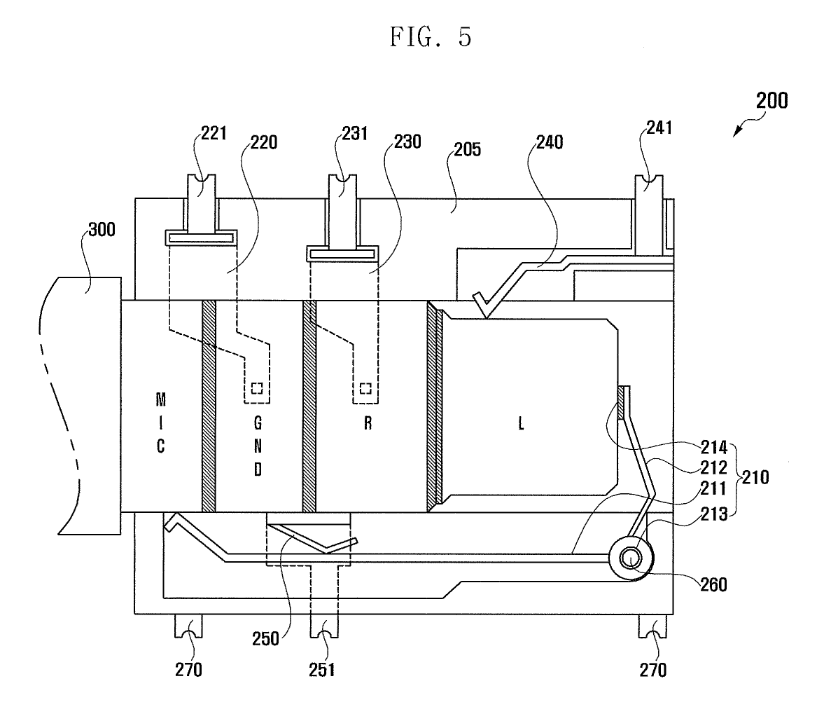

FIG. 4 is a diagram illustrating a structure of a 4-pole earphone connector of a mobile terminal according to another embodiment of the present invention, and FIG. 5 is a diagram illustrating a state in which a 4-pole earphone is inserted into the earphone connector of the mobile terminal of FIG. 4.

Referring to FIGS. 4 and 5, a 4-pole earphone connector 200 of a mobile terminal according to an embodiment of the present invention includes a main body 205 having a passage for inserting a 4-pole earphone 300, microphone terminal 210, ground terminal 220, right sound terminal 230, left sound terminal 240, elastic member 250, rotation shaft 260, and at least one fixing terminal 270 for fixing the main body 205 to a PCB (not shown).

The 4-pole earphone connector 200 according to an embodiment is similar to that of the embodiment illustrated in FIGS. 2 and 3, except that a position of the elastic member 250 is changed. That is, as shown in FIG. 4, the elastic member 250 is positioned adjacent to a first connection portion 211 of the microphone terminal 210 to press the first connection portion 211 in an outside direction of the main body 205, away from the passage for inserting a 4-pole earphone 300. When the 4-pole earphone 300 is fully inserted, a left sound terminal L of the 4-pole earphone 300 pushes the second connection portion 212 in a traveling direction (insertion direction), as shown in FIG. 5. Thereby, the microphone terminal 210 rotates about a rotation shaft 260. By the rotation, the first connection portion 211 contacts with a microphone terminal MIC of the 4-pole earphone 300. In this situation, the elastic member 250 is compressed, as shown in FIG. 5. A detailed description of other constituent elements is similar to the foregoing embodiment described with reference to FIGS. 2 and 3 and therefore a detailed description thereof is omitted.

In the 4-pole earphone connectors 100 and 200 described with reference to FIGS. 2 to 5, the microphone terminals 110 and 210 are not fixed at a specific position unlike the conventional 4-pole earphone connector, and thus when the 4-pole earphone 300 is inserted or removed, the microphone terminals 110 and 210 and the left sound terminal L or the right sound terminal R of the 4-pole earphone 300 are not in contact with the first connection portion 211 of the microphone terminal 210. The 4-pole earphone connectors 100 and 200 may be mounted in a mobile terminal such as a mobile communication terminal, a smart phone, and a tablet PC for providing an earphone connection function. Therefore, when an earphone is inserted into or removed from an earphone connector mounted in a mobile terminal according to the present invention, noise does not occur.

For example, the present invention can be equally applied to even a 5-pole earphone connector including a microphone terminal. Furthermore, the microphone terminal, ground terminal, left sound terminal, right sound terminal, and main body shown in FIGS. 2 to 5 can be changed in various forms.

As described above, when an earphone is inserted into or removed from an earphone connector of a mobile terminal according to an embodiment of the present invention, a microphone terminal of the earphone connector does not physically contact with a left sound terminal or a right sound terminal of the earphone, and thus noise does not occur.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. An earphone connector of a mobile terminal, comprising:
a main body comprising a passage for inserting an earphone;
a ground terminal, a right sound terminal, and a left sound terminal disposed at positions along the passage and configured to make contact with a corresponding ground terminal, a corresponding right sound terminal, and a corresponding left sound terminal, respectively, of the earphone that is inserted into the passage;
a microphone terminal configured to make contact with a corresponding microphone terminal of the earphone when the earphone is fully inserted into the passage; and
an elastic member configured to apply an external force such that the microphone terminal is not in contact with at least one of the corresponding right sound terminal and the corresponding left sound terminal of the earphone when the earphone is being inserted into the passage.

2. The earphone connector of claim 1, wherein the microphone terminal comprises:
a first connection portion configured to make contact with the corresponding microphone terminal of the earphone;
a second connection portion configured to form an angle with the first connection portion and pressed by the corresponding left sound terminal of the earphone when the earphone is inserted into the passage; and
a hole formed in a connecting portion of the first connection portion and the second connection portion and configured to insert a rotation shaft,
wherein the second connection portion comprises an insulation member that is pressed by the corresponding left sound terminal of the earphone when the earphone is inserted into the passage.

3. The earphone connector of claim 2, wherein the elastic member is positioned between the first connection portion and the passage to press the first connection portion in an outside direction of the main body such that the first connection portion does not make contact with the earphone until the earphone is fully inserted into the passage.

4. The earphone connector of claim 2, wherein the elastic member is positioned at a closed end portion of the passage to press the second connection portion toward an open end portion of the passage.

5. The earphone connector of claim 1, wherein the elastic member comprises a connection terminal configured to fix the elastic member and receive microphone bias power from a power source of a printed circuit board (PCB).

6. The earphone connector of claim 1, wherein the elastic member is a ‘C’-shaped clip.

7. The earphone connector of claim 2, wherein the microphone terminal is configured to rotate about the rotation shaft when the second connection portion is pressed by the corresponding left sound terminal of the earphone.

8. A mobile terminal comprising:
a mobile terminal body; and
an earphone connector mounted in the mobile terminal body to connect an earphone comprising a microphone,
wherein the earphone connector comprises:
a main body comprising a passage for inserting the earphone;
a ground terminal, aright sound terminal, and a left sound terminal disposed at positions along the passage and configured to make contact with a corresponding ground terminal, a corresponding right sound terminal, and a corresponding left sound terminal, respectively, of the earphone when the earphone is inserted into the passage;
a microphone terminal configured to make contact with a corresponding microphone terminal of the earphone when the earphone is fully inserted into the passage; and
an elastic member configured to apply an external force such that the microphone terminal is not in contact with at least one of the corresponding right sound terminal and the corresponding left sound terminal of the earphone when the earphone is being inserted into the passage.

9. The mobile terminal of claim 8, wherein the microphone terminal comprises:
a first connection portion configured to make contact with the corresponding microphone terminal of the earphone;
a second connection portion configured to form an angle with the first connection portion and pressed by the corresponding left sound terminal of the earphone when the earphone is inserted into the passage; and
a hole formed in a connecting portion of the first connection portion and the second connection portion and configured to insert a rotation shaft,
wherein the second connection portion comprises an insulation member that is pressed by the corresponding left sound terminal of the earphone when the earphone is inserted into the passage.

10. The mobile terminal of claim 9, wherein the elastic member is positioned between the first connection portion and the passage to press the first connection portion in an outside direction of the main body such that the first connection portion does not make contact with the earphone until the earphone is fully inserted into the passage.

11. The mobile terminal of claim 9, wherein the elastic member is positioned at a closed end portion of the passage to press the second connection portion toward an open end portion of the passage.

12. The mobile terminal of claim 8, wherein the elastic member comprises a connection terminal configured to fix the elastic member and receive microphone bias power from a power source of a printed circuit board (PCB).

13. The mobile terminal of claim 8, wherein the elastic member is a ‘C’-shaped clip.

14. The mobile terminal of claim 9, wherein the microphone terminal is configured to rotate about the rotation shaft when the second connection portion is pressed by the corresponding left sound terminal of the earphone.

15. An earphone connector comprising:
a cavity comprising an open end and a closed end configured to insert an earphone through the open end toward the closed end;
a ground terminal, a right sound terminal, and a left sound terminal disposed at positions along the cavity such that each of the ground terminal, the right sound terminal, and the left sound terminal is configured to make contact with a corresponding ground terminal, a corresponding right sound terminal, and a corresponding left sound terminal of the earphone, respectively, when the earphone is fully inserted into the cavity;
a microphone terminal configured make contact with a corresponding microphone terminal of the earphone when the earphone is fully inserted into the cavity such that the microphone does not make contact with at least one of the corresponding ground terminal, the corresponding right sound terminal, and the corresponding left sound terminal of the earphone while the earphone is being inserted into the cavity.

16. The earphone connector of claim 15, wherein the microphone terminal comprises:
a first connection portion configured to make contact with the corresponding microphone terminal of the earphone when the earphone is fully inserted into the cavity;
a second connection portion configured to form an angle with the first connection portion and pressed by an end of the earphone when the earphone is fully inserted into the cavity; and
a connecting portion coupled to the first connection portion and the second connection portion, the connecting portion comprising a hole in which a rotation shaft is inserted,
wherein the second connection portion comprises an insulation member that is pressed by the corresponding left sound terminal of the earphone when the earphone is inserted into the cavity.

17. The earphone connector of claim 16, further comprising an elastic member configured to apply a force such that the microphone terminal is not in contact with at least one of the corresponding right sound terminal and the corresponding left sound terminal of the earphone when the earphone is being inserted into the cavity.

18. The earphone connector of claim 17, wherein the elastic member is positioned between the first connection portion and the cavity and configured to press the first connection portion in a direction away from the cavity such that the first connection portion does not make contact with the earphone until the earphone is fully inserted into the cavity.

19. The earphone connector of claim 17, wherein the elastic member is positioned at the closed end of the cavity to press the second connection portion toward the open end portion of the cavity.

20. The earphone connector of claim 15, wherein the elastic member is a ‘C’-shaped clip.
